(19) United States
(12) Patent Application Publication
(10) Pub. No.: US 2009/0134131 A1
(43) Pub. Date: May 28, 2009

(54) LASER WELDING METHOD FOR GALVANIZED STEEL SHEETS

(75) Inventors: Mun Yong LEE, Busan-city (KR); Young Chae SONG, Busan-city (KR)

Correspondence Address: LEXYOUME IP GROUP, LLC, 5180 PARKSTONE DRIVE, SUITE 175, CHANTILLY, VA, 20151, US

(73) Assignee: SUNGWOO HITECH CO., LTD., Busan-city (KR)

(21) Appl. No.: 12/039,487

(22) Filed: Feb. 28, 2008

(30) Foreign Application Priority Data
Nov. 22, 2007 (KR) 10-2007-0119737

(51) Int. Cl. B23K 26/20

(52) U.S. Cl. 219/121.64

(57) ABSTRACT

The present invention relates to a laser welding method for galvanized steel sheets where galvanized steel sheets are lap-welded by using a laser beam of a keyhole welding zone in a state in which a gap for exhausting zinc fumes is formed by embossing a plurality of protrusions along a welding line on one galvanized steel sheet among the galvanized steel sheets by using a laser beam of a conducting welding region.

### CROSS-REFERENCE TO RELATED APPLICATION

This application claims priority to and the benefit of Korean Patent Application No. 10-2007-0119737 filed in the Korean Intellectual Property Office on Nov. 22, 2007, the entire contents of which are incorporated herein by reference.

### BACKGROUND OF THE INVENTION

(a) Field of the Invention

The present invention relates to a laser welding method for galvanized steel sheets. More particularly, the present invention relates to a laser welding method for galvanized steel sheets where galvanized steel sheets are lap-welded by using a laser beam of a keyhole welding zone in a state in which a gap for exhausting zinc fumes is formed by embossing a plurality of protrusions along a welding line on one galvanized steel sheet among the galvanized steel sheets by using a laser beam in the welding region.

(b) Description of the Related Art

Generally, laser welding is classified into keyhole welding using energy reflection and absorption in a focal region of a laser beam, and conducting welding using thermal conduction in a non-focal region of a laser beam.

Keyhole welding and conducting welding will be described in detail. As shown in FIG. 1, a keyhole welding region T1 represents the focal region where a laser beam LB is converged by a lens and energy is reflected at a material surface or is absorbed in the material. The distance of the keyhole welding region T1 from a focus is within 2 mm. A conducting welding region T2 represents a non-focal region that is away from the keyhole welding region T1 of the laser beam LB. In the conducting welding region T2, thermal conduction enables the material to be welded.

That is, according to keyhole welding that is performed at the keyhole welding region T1, electromagnetic waves of the laser beam LB collide with the material surface at a focal point where the laser beam is converged, collision energy is transformed into heat energy, and a keyhole effect occurs. Such keyhole effect means a state where welding is performed when a plurality of small holes are made in a melting pool by vapor pressure.

On the contrary, conducting welding performed at the conducting welding region T2 is performed at the non-focal region of the laser beam LB. The area of the conducting welding region T2 is larger than that of the keyhole welding region T1. Therefore, the laser beam density at the conducting welding region T2 is lower than the laser beam density at the keyhole welding region Ti, but a small amount of metal vapor is generated and a welding pattern of a half-moon shape is achieved when the laser beam LB is collided with a material surface according to conducting welding.

As described above, laser welding is performed on steel sheets or aluminum alloy sheets by using characteristics of the laser beam LB.

FIG. 2 is schematic view of a conventional laser welding system. In order to weld steel sheets or aluminum alloy sheets by using a laser beam LB, a laser head 5 is mounted at a front portion of an arm 3 of a robot 1 and is connected to a laser oscillator 7. The laser head 5 is moved along a welding line of material 9 by the robot 1 that is controlled by a robot controller C and irradiates a laser beam LB to the material 9 so as to weld the material 9.

Here, all steel sheets that are plated with zinc will be called galvanized steel sheets, and galvanized steel sheets are broadly classified into hot dipped galvanized iron and electrolytic galvanized iron according to a manufacturing method thereof. Use of such galvanized steel sheets has increased since zinc protects metal against rust and has no effect on strength and economic efficiency.

However, when galvanized steel sheets 11 are lap-welded by using the characteristic of the laser beam as shown in FIG. 3, zinc fumes generated by evaporation of a zinc layer 13 at a welding portion W cause explosive pores at the overlapped galvanized steel sheets 11 if a gap does not exist between the overlapped galvanized steel sheets 11 as shown in FIG. 4.

Accordingly, it is important that a gap is maintained at about 0.1 mm by using a jig between the overlapped galvanized steel sheets 11 so as to exhaust zinc fumes when galvanized steel sheets 11 are lap-welded.

However, if a jig is used to maintain the gap between the galvanized steel sheets 11, the jig cannot be used to weld steel sheets that are not plated with zinc.

In addition, since the gap between the galvanized steel sheets 11 is not maintained to be constant in the case of using the jig, explosive pores may be formed at the galvanized steel sheets 11.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a laser welding method for galvanized steel sheets having advantages that galvanized steel sheets are lap-welded by using laser beam of a keyhole welding zone in a state in which a gap for exhausting zinc fumes is formed by embossing a plurality of protrusions along a welding line on one galvanized steel sheet among the galvanized steel sheets by using a laser beam of a conducting welding region.

A laser welding method for galvanized steel sheets according to an exemplary embodiment of the present invention may include: embossing a plurality of protrusions along a welding line on one galvanized steel sheet among galvanized steel sheets to be lap-welded by using a laser beam of a conducting welding region for thermal distortion, the plurality of protrusions being embossed at both sides of the welding line; loading the galvanized steel sheets to be lap-welded on a jig in a state in which the other galvanized steel sheets are put on one surface where the plurality of protrusions are embossed of the one galvanized steel sheet; and laser welding the galvanized steel sheets that are overlapped with each other along the welding line by using a laser beam of a keyhole welding zone.

The laser beam may be oscillated by a Nd:YAG laser oscillator.

The protrusions may be alternately embossed at both sides of the welding line on the one galvanized steel sheet with a zigzag shape. The height of the protrusions may be less than or equal to 0.2 mm.

### BRIEF DESCRIPTION OF THE DRAWINGS

FIG. 1 is a schematic view of focal region of a laser beam.

FIG. 2 is schematic view of a conventional laser welding system.

FIG. 3 is a schematic view showing the state of galvanized steel sheets that are welded by using a laser beam of a keyhole welding region.

FIG. 4 is a schematic view of a welded portion according to a conventional laser welding method for galvanized steel sheets.

FIG. 5 is a flow chart of a laser welding method for galvanized steel sheets according to an exemplary embodiment of the present invention.

FIG. 6 is a schematic view of embossing protrusions on a galvanized steel sheet at the step Si in FIG. 5.

FIG. 7 is a schematic view of a welded portion according to a laser welding method for galvanized steel sheets of this invention.

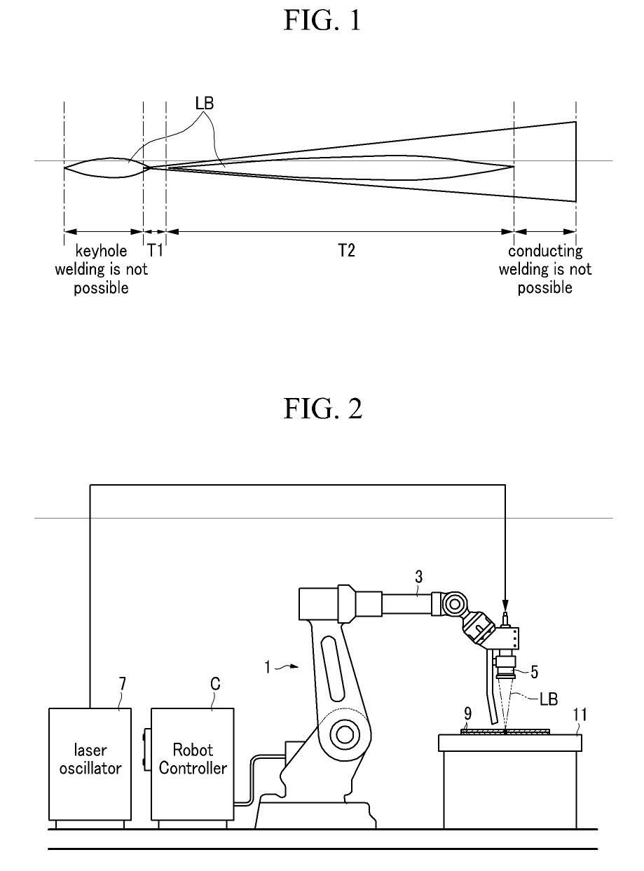

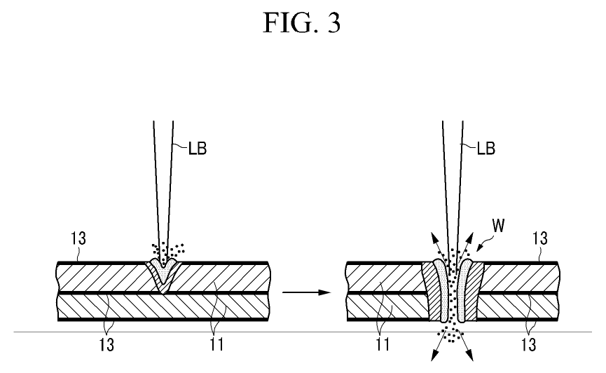

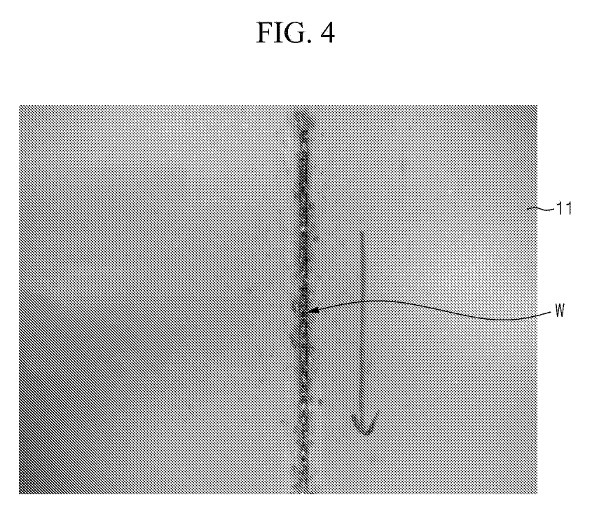

### DETAILED DESCRIPTION OF THE EMBODIMENTS

Hereinafter, an exemplary embodiment of the present invention will be described in detail with reference to the accompanying drawings.

When the present invention is described, the same reference numerals will be given to the same or similar constituent elements throughout.

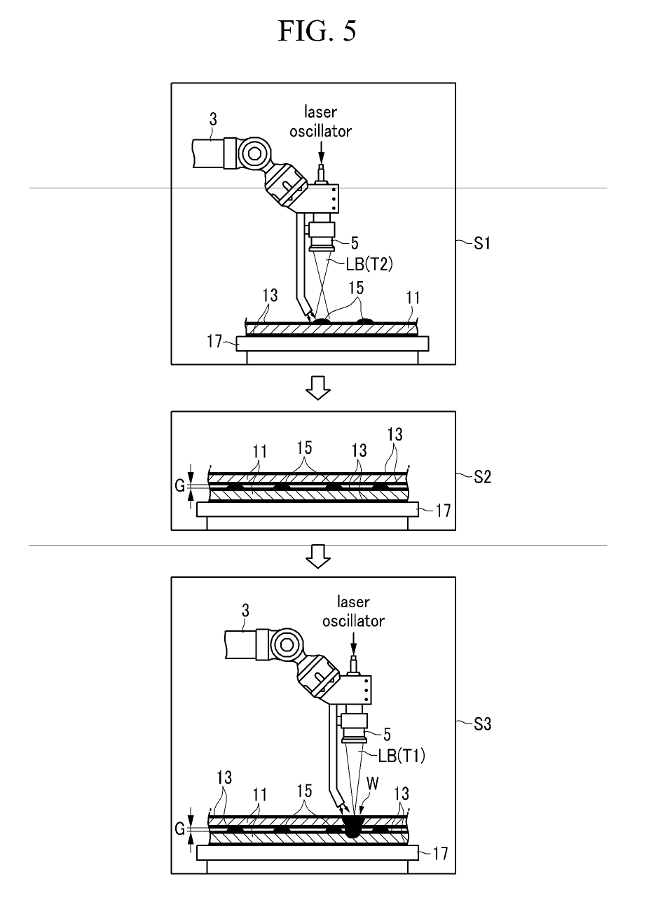

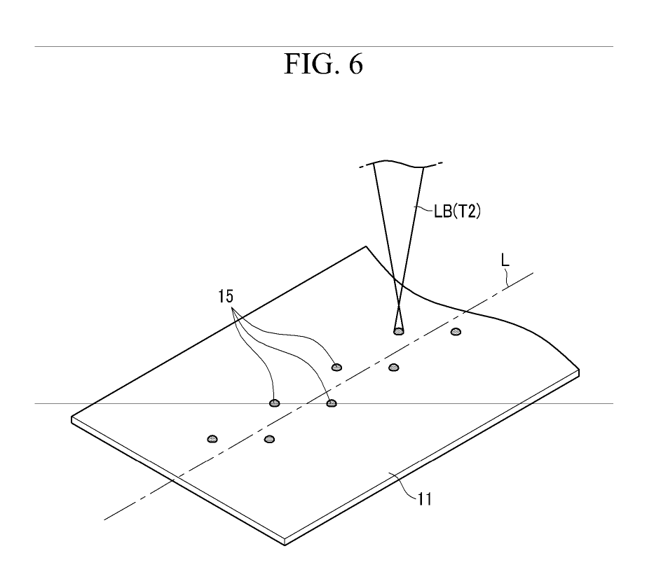

FIG. 5 is a flow chart of a laser welding method for galvanized steel sheets according to an exemplary embodiment of the present invention, and FIG. 6 is a schematic view of embossing protrusions on a galvanized steel sheet at the step S1 in FIG. 5.

According to a laser welding method for galvanized steel sheets of this invention, a plurality of protrusions 15 are embossed along a welding line L on one galvanized steel sheet 11 of two galvanized steel sheets 11 to be lap-welded by using a laser beam LB of the conducting welding region T2 for thermal distortion at a step S1, as shown in FIG. 5. The plurality of protrusions are embossed at both sides of the welding line L.

That is, as shown in FIG. 6, the robot 1 is moved along the welding line L and the laser head 5 irradiates the laser beam LB of the conducting welding region T2 to the one galvanized steel sheet 11 in order to emboss the plurality of protrusions 15 on the one galvanized steel sheet 11.

In the case that a pulse wave laser beam LB of the conducting welding region T2 is irradiated to the surface of the one galvanized steel sheet 11, the surface of the one galvanized steel sheet 11 is fused by high density heat energy and is quickly solidified. At this time, heat energy is thermally conducted to the surface of the one galvanized steel sheet 11 and the surface of the one galvanized steel sheet swells up to have a dome shape. Thus, the protrusions 15 are embossed.

Such protrusions 15 are embossed on a junction surface of the one galvanized steel sheet 11 so as to be welded with the other galvanized steel sheet 11. Output, irradiation speed, location of the focus, and irradiating duration of the laser beam LB can be easily set by a person skilled in the art, and the height of the protrusions 15 is preferably less than or equally to 0.2 mm.

In addition, the protrusions 15 may be alternately embossed at both sides of the welding line L on the one galvanized steel sheet 11 with a zigzag shape.

The laser beam may be oscillated by a Nd:YAG laser oscillator.

After the plurality of protrusions 15 are embossed along the welding line L on the junction surface of the one galvanized steel sheet 11, the other galvanized steel sheet 11 is put on the junction surface of the one galvanized steel sheet 11 and the galvanized steel sheets to be lap-welded are loaded on the jig 17 at a step S2.

At this time, respective welding lines L of the respective galvanized steel sheets 11 must correspond.

After that, the overlapped galvanized steel sheets 11 are laser welded along the welding line L by irradiating the laser beam LB of the keyhole welding region T1 at a step S3.

That is, in order to laser weld the overlapped galvanized steel sheets 11, the robot 1 is moved along the welding line of the galvanized steel sheets 11 and the laser head 5 irradiates the laser beam LB of the keyhole welding region T1 to the overlapped galvanized steel sheets 11.

The laser beam LB may also be oscillated by the Nd:YAG laser oscillator.

Therefore, in the case in which the galvanized steel sheet 11 are lap-welded according to the laser welding method of this invention, the gap G for exhausting zinc fumes generated by evaporation of the zinc layer 13 is formed between the galvanized steel sheets 11 as a consequence of the plurality of protrusions 15 embossed on the one galvanized steel sheet 11 along the welding line L.

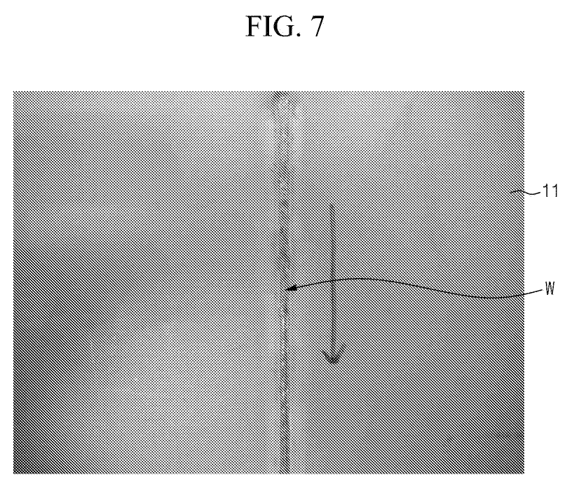

Therefore, when the galvanized steel sheets 11 are lap-welded using the laser beam LB of the keyhole welding region T1, zinc fumes may be easily exhausted through the gap G and the pores may not be generated. Therefore, welding quality may improve, as shown in FIG. 7.

In addition, the jig for maintaining the gap G between the galvanized steel sheets 11 may not be needed, according to the exemplary embodiment of the present invention.

According to the present invention, the galvanized steel sheets are overlapped with each other after the protrusions are embossed along the welding line on the one galvanized steel sheets by using the laser beam of a conducting welding region. Therefore, the gap for exhausting zinc fumes is formed between the galvanized steel sheets by the protrusions. In this state, the galvanized steel sheets are lap-welded by using the laser beam of the keyhole welding region. Therefore, explosive pores may not be generated at the galvanized steel sheets, and thus, welding quality may improve.

In addition, the jig for maintaining the gap between the galvanized steel sheets may not be needed according to the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A laser welding method for galvanized steel sheets, comprising:
embossing a plurality of protrusions along a welding line on one galvanized steel sheet among galvanized steel sheets to be lap-welded by using a laser beam of a conducting welding region for thermal distortion, the plurality of protrusions being embossed at both sides of the welding line;
loading the galvanized steel sheets to be lap-welded on a jig in a state in which the other galvanized steel sheets are put on one surface where the plurality of protrusions are embossed of the one galvanized steel sheet; and
laser welding the galvanized steel sheets that are overlapped with each other along the welding line by using a laser beam of a keyhole welding zone.

2. The laser welding method of claim 1, wherein the laser beam is oscillated by a Nd:YAG laser oscillator.

3. The laser welding method of claim 1, wherein the protrusions are alternately embossed at both sides of the welding line on the one galvanized steel sheet with a zigzag shape.

4. The laser welding method of claim 1, wherein height of the protrusions is less than or equal to 0.2 mm.
